(19) United States
(12) Patent Application Publication
(10) Pub. No.: US 2003/0198865 A1
(43) Pub. Date: Oct. 23, 2003

(54) Cell fast fixing structure of starting box

(76) Inventor: Tracy Lai, Taichung (TW)

Correspondence Address: Tracy Lai, P.O. BOX 2103, Taichung, TW

(21) Appl. No.: 10/124,218

(22) Filed: Apr. 17, 2002

(51) Int. Cl. H01M 2/10

(52) U.S. Cl. 429/100; 429/97; 429/99

(57) ABSTRACT

A cell fast fixing structure of starting box, including a cell seat and a locating member disposed in the starting box. A stop board is pivotally connected with the cell seat. Cells are placed between the cell seat and the locating member. The stop board can be pivotally turned onto the cell seat to fix and prevent the cells from dropping out.

### BACKGROUND OF THE INVENTION

The present invention is related to a cell fast fixing structure of a starting box, and more particularly to a cell fixing structure enabling a user to quickly fix cells in or take out cells from a starting box for starting the engine of a remote controllable power model.

The engine of a conventional remote controllable power model is started by a starting box. The starting box is powered by cells. Therefore, a cell fixing structure is disposed in the starting box for fixing cells.

FIG. 6 shows a conventional cell fixing structure. Two sets of fastening straps 7 are disposed on inner faces of two sides of the starting box 5. The cells 6 are positioned between the fastening straps 7 and then the fastening straps 7 are latched with each other to fix the cells 6. A gap often exists between the fastening straps 7 and the cells 6 to facilitate latching of the fastening straps 7. However, this makes the fastening straps 7 unable to tighten the cells 6 in axial direction Accordingly, in use, the cells 6 often loosen and disconnect from the electrodes. As a result, the starting box 5 will fail. In another type of conventional cell fixing structure, magic attachable tapes are used instead of the fastening straps. The magic attachable tapes are attached to each other to fix the cells. Such measure is similar to the fastening straps and fails to firmly fix the cells. Therefore, the cells are still likely to loosen.

FIG. 7 shows another type of conventional cell fixing structure of a starting box. Two C-shaped retainers 82 are fixed on inner faces of two sides of the starting box 8. The C-shaped retainers 82 are made of metal sheets by punching. The openings of the C-shaped retainers 82 face each other. A cell 81 can be fixedly held by the C-shaped retainers 82. The C-shaped retainers 82 must be fixed on the inner faces by means of welding or riveting. Such procedure is troublesome. Furthermore, in order to have better fixing effect for the cell, the C-shaped retainers 82 are previously compressed to reduce the internal spaces thereof so as to tightly hold the cell 81. However, the openings of the C-shaped retainers 82 are also narrowed so that it is hard to insert the cell 81 into the C-shaped retainers 82. Moreover, after a period of use, the C-shaped retainers 82 will suffer elastic failure and the internal spaces of the C-shaped retainers 82 will be enlarged. As a result, the cell 81 can be hardly fixed and is likely to loosen.

FIG. 8 shows still another type of conventional cell fixing structure of starting box. A lower fixing seat 92 is fixed in the starting box 9. An upper fixing seat 93 is mated with the lower fixing seat 92 to cover the same. The lower and upper fixing seats 92, 93 define a receiving space corresponding the cross-sectional shape of the cell 91. The cell 91 is placed on the lower fixing seat 92 and covered by the upper fixing seat 93 and tightened by a screw. Such structure has a shortcoming, that is, a user must use a tool to tighten or untighten the cell. Furthermore, the upper and lower fixing seats 93, 92 are separate members so that the upper fixing seat 93 is easy to miss.

### SUMMARY OF THE INVENTION

It is therefore a primary object of the present invention to provide a cell fast fixing structure of starting box. The cell fixing structure includes a cell seat and a locating member disposed in the starting box for locating two ends of a cell. A stop board is pivotally connected with the cell seat. In normal using state, one end of the cell is restricted in the locating member and the weight of the other end of the cell falls onto the stop board. The pivot section of the stop board is positioned between two ends of the cell located in the cell seat. The pivot section serves as a suspending fulcrum of the stop board. When the stop board suffers the downward action force caused by the weight of the cell, the stop board can only substantially transversely displaced. Therefore, the weight of the cell is effectively supported by the stop board to firmly fix the cell.

It is a further object of the present invention to provide the above cell fast fixing structure of starting box, in which after the stop board is turned to cover the top side of the cell, the latch plate of the stop board is latched with the projecting section of the pivot seat. Therefore, the stop board cannot freely rotate so that the cell is more firmly fixed without loosening.

The present invention can be best understood through the following description and accompanying drawings wherein:

### BRIEF DESCRIPTION OF THE DRAWINGS

FIG. 1 is a perspective view of the present invention, showing that the bottom face of the starting box faces upward for loading cells into the starting box;

FIG. 2 is a perspective exploded view of the present invention, showing that the bottom face of the starting box faces upward for loading cells into the starting box;

FIG. 3 is a sectional assembled view of the present invention, showing that the bottom face of the starting box faces upward for loading cells into the starting box;

FIG. 4 is a view according to FIG. 3, showing that the cells are loaded into the starting box;

FIG. 5 is a sectional view of the present invention, showing that in normal operation state, the stop board under the cells supports the cells;

FIG. 6 shows a conventional cell fixing structure of a starting box;

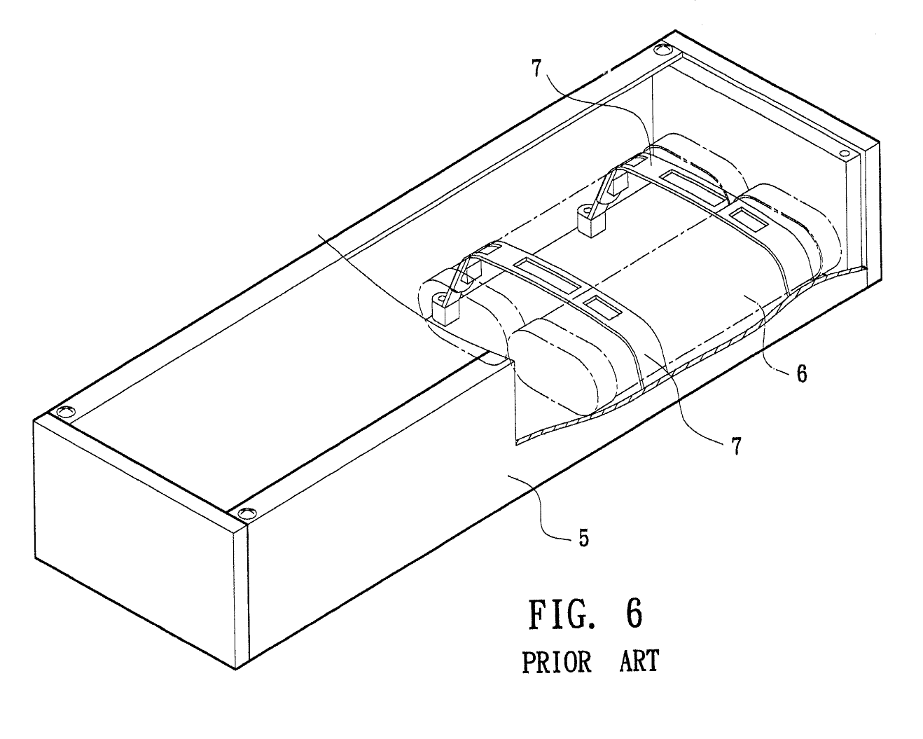

FIG. 7 shows another type of conventional cell fixing structure of a starting box; and

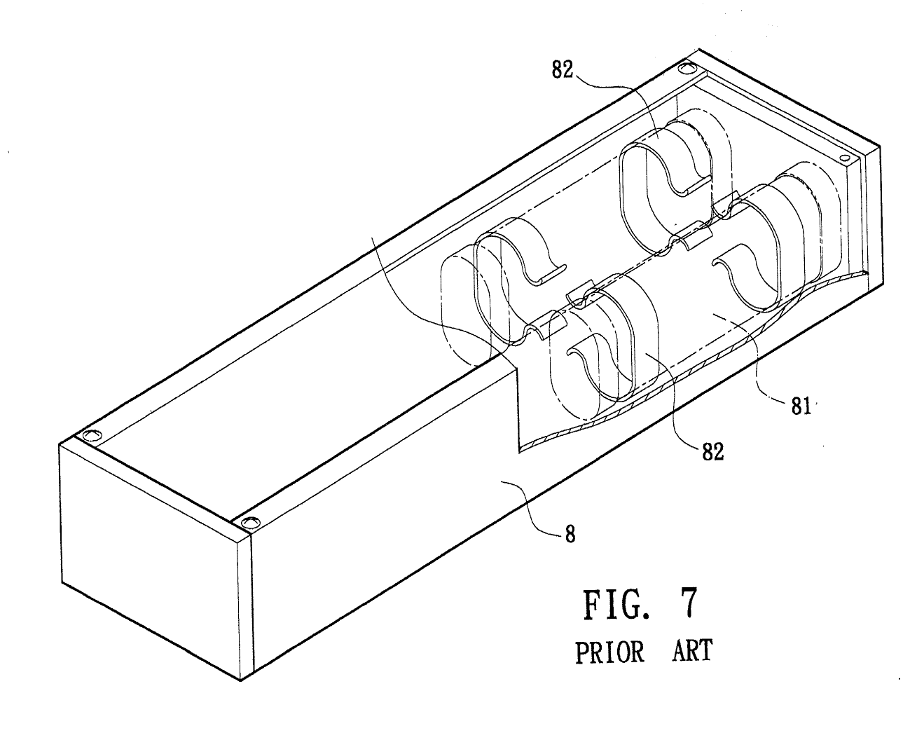

FIG. 8 shows still another type of conventional cell fixing structure of a starting box

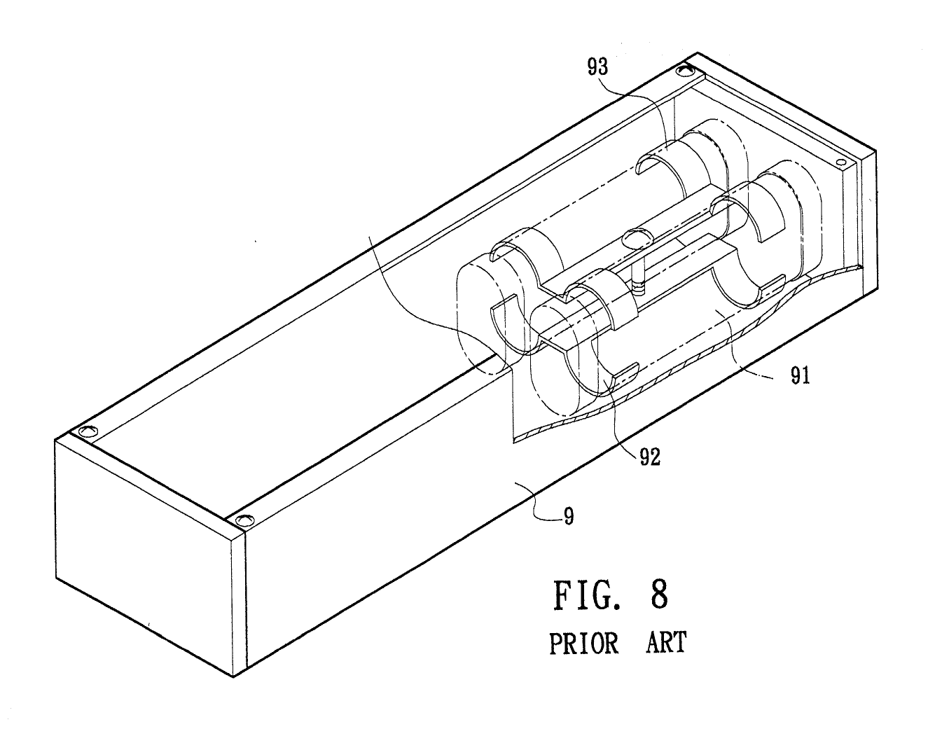

### DETAILED DESCRIPTION OF THE PREFERRED EMBODIMENTS

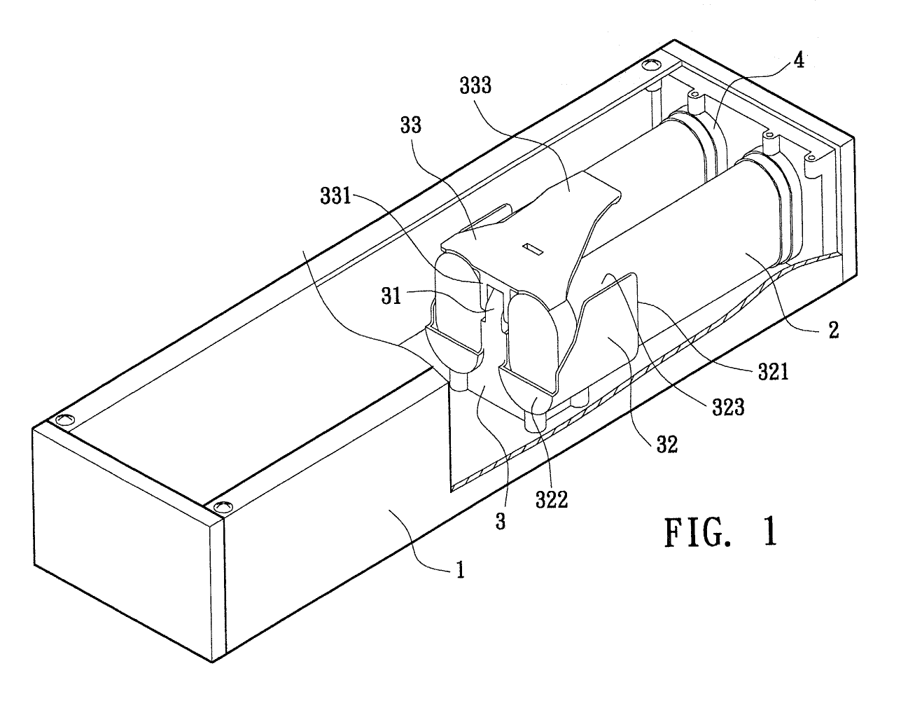

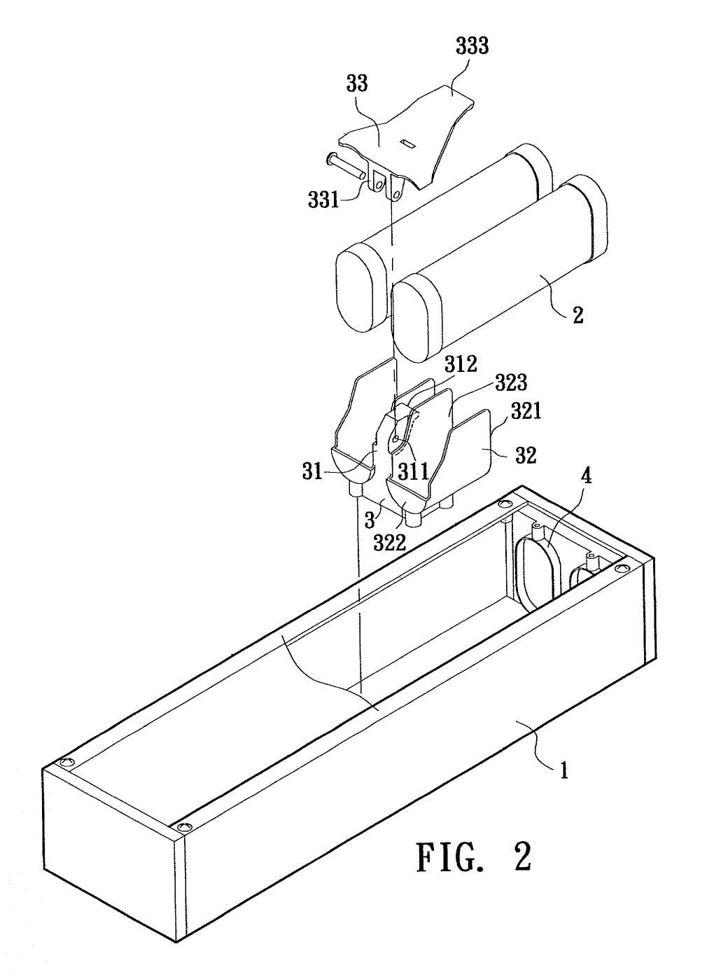

Please refer to FIGS. 1 to 3 in which the bottom face of the starting box 1 faces upward for easy description. However, the scope of the present invention is not limited to such aspect.

The cell fast fixing structure of starting box of the present invention includes a cell seat 3 fixed in the starting box 1. The cell seat 3 has a pivot seat 31 and two receptacles 32 on two sides of the pivot seat 31. The pivot seat 31 has a pivot hole 311 and a projecting section 312. In FIGS. 1 to 3, the top side of each receptacle 32 is formed with an opening 323. (In actual use of the starting box, the opening faces downward.) Two ends of the receptacle 32 are respectively formed with an open end 321 and a stop end 322. One end of a cell 2 is received in the receptacle 32.

A locating member 4 is disposed in the starting box 1 corresponding to the open end 321 for locating the other end of the cell 2. In this embodiment, the locating member 4 is a socket for inlaying the other end of the cell 2 therein.

The present invention further includes a stop board 33 having a pivot section 331, a latch plate 332 and a driven section 333 extending toward the locating member 4 The pivot section 331 is pivotally connected with the pivot seat 31 at the pivot hole 311 thereof. The latch plate 332 is latched with the projecting section 312 of the pivot seat 31. In this embodiment, the pivot section 331 of the stop board 33 is positioned between the two receptacles 32. The lateral portions of the stop board 33 on two sides of the pivot section 331 serve to stop the cells 2 received in the receptacles 32.

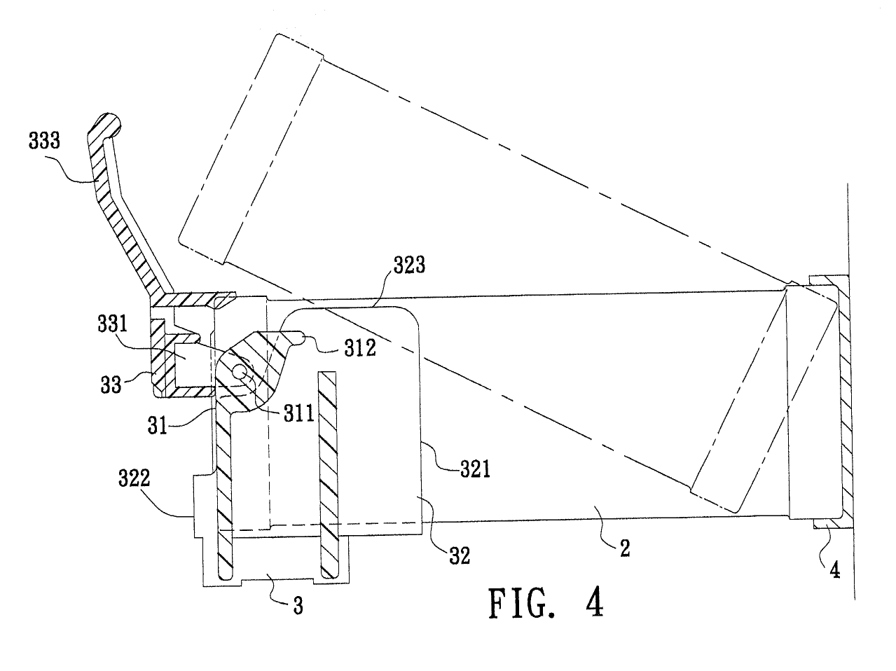

When loading the cell 2 into the starting box, as shown in FIG. 4 in which the bottom face of the starting box faces upward, the driven section 333 is first biased to turn the stop board 33 upward. Then, one end of each cell 2 is inlaid in a locating member 4. The other end of each cell 2 is fitted into the receptacle 32 through the opening 323 of the cell seat 3. Then the stop board 33 is pressed and turned to make two sides of the stop board 33 press the top sides of the cells 2 so as to fast fix the cells 2. Reversely, when taking out the cells 2, the driven section 333 is first biased to turn the stop board 33 upward so as to fast take out the cells 2. Accordingly, simply by means of pivotally turning the stop board 33, the cells 2 can be quickly fixed or taken out.

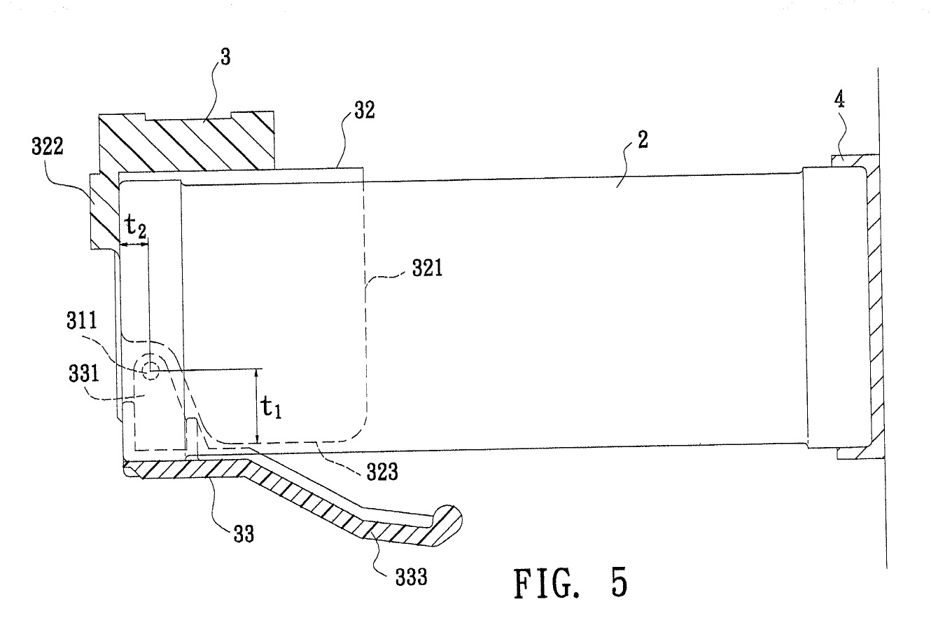

It should be noted that the pivot hole 311 of the starting box 1 for pivotally connecting with the stop board 33 is positioned in a position between the open end 321 and the stop end 322. Practically, the position of the pivot hole 311 is preferably slightly proximal to the stop end 322. The pivot hole 311 is spaced from the opening 323 of the receptacle 32 by a distance t₁. The pivot hole 311 is spaced from the stop end 322 by a distance t₂. The distance t₁ is larger than the distance t₂. In actual use of the starting box 1, the starting box 1 is turned to a normal using state in which the cell seat 3 faces the ground as shown in FIG. 5. One end of the cell 2 is restricted in the locating member 4 and the weight of the other end of the cell 2 falls onto the stop board 33. The pivot hole 311 serves as a suspending fulcrum of the stop board 33. In the case that the stop board 33 under the cells 2 are displaced, the stop board 33 can only swing about the pivot section 331 pivotally connected at the pivot hole 311. Moreover, the distance t₁ between the pivot hole 311 and the opening 323 of the receptacle 32 is larger than the distance t₂ between the pivot hole 311 and the stop end 322. Therefore, the displacement direction of the stop board 33 under the cells 2 is nearly transverse. Therefore, the weight of the cells 2 can be effectively supported to prevent the cells 2 from dropping down.

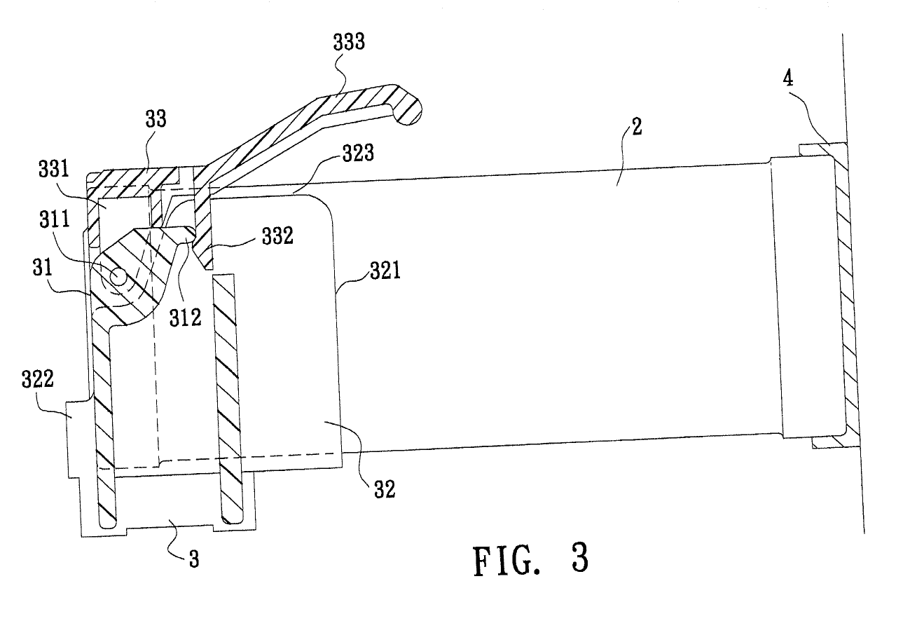

In addition, as shown in FIG. 3, when the stop board 33 is pressed and turned to cover the top sides of the cells 2, the latch plate 332 of the stop board 33 is latched with the projecting section 312 of the pivot seat 31. Therefore, in actual use, the stop board 33 under the cells 2 is unable to freely rotate so that the cells 2 are more firmly fixed without loosening.

The above embodiments are only used to illustrate the present invention, not intended to limit the scope thereof. Many modifications of the above embodiments can be made without departing from the spirit of the present invention.

What is claimed is:

1. A cell fast fixing structure of starting box, comprising a cell seat fixed in the starting box, the cell seat having at least one receptacle and a pivot seat, each receptacle having an opening through which one end of a cell is placed into the receptacle, two ends of the receptacle being respectively formed with an open end and a stop end, a locating member being disposed in the starting box corresponding to the open end for inlaying the other end of the cell in the locating member, the pivot seat having a pivot hole positioned in a position between the open end and the stop end, the distance between the pivot hole and the opening of the receptacle being larger than the distance between the pivot hole and the stop end, a stop board being pivotally connected with the pivot seat at the pivot hole thereof, the stop board having a pivot section and a driven section extending toward the locating member, whereby after pivotally turned, the stop board serves to block the opening of the receptacle.

2. The cell fast fixing structure of starting box as claimed in claim 1, wherein the cell seat has two receptacles and the pivot seat is disposed between the two receptacles.

3. The cell fast fixing structure of starting box as claimed in claim 1, wherein the pivot seat has a projecting section and the stop board has a latch plate corresponding to the projecting section, whereby after the stop board is turned to block the opening of the receptacle, the latch plate is latched with the projecting section.

4. The cell fast fixing structure of starting box as claimed in claim 1, wherein the locating member is a socket in which one end of the cell is inlaid.
